(19) United States
(12) Patent Application Publication
(10) Pub. No.: US 2026/0320776 A1
(43) Pub. Date: Oct. 15, 2026

(54) MEASURING APPARATUS AND PROGRAM

(71) Applicant: Mitutoyo Corporation, Kawasaki (JP)

(72) Inventor: Yui Miyake, Kanagawa (JP)

(21) Appl. No.: 19/640,770

(22) Filed: Apr. 7, 2026

(30) Foreign Application Priority Data
Apr. 15, 2025 (JP) 2025-067150

(51) Int. Cl. G06T 7/00; G06V 10/141; G06V 20/64

(52) U.S. Cl. CPC G06T 7/001; G06V 10/141; G06V 20/647; G06T 2207/20092; G06T 2207/30164

(57) ABSTRACT

A measuring apparatus and program that enable an operator to easily understand the recorded measurement procedure for a measurement object to be measured are provided. The measuring apparatus comprises: a mounting stage on which the measurement object is placed; an imaging device that captures an image of the measurement object placed on the mounting stage; a memory that stores a measurement program recording the measurement procedure for a master workpiece associated with a thumbnail image of the master workpiece; a display that displays the image of the measurement object captured by the imaging device and a user interface of measurement application software used for analyzing the image; and a processor that executes the measurement application software. The processor prompts the operator to select the measurement program by displaying the thumbnail images associated with each measurement program on the display by means of the measurement application software, and executes the measurement procedure recorded in the selected measurement program.

### CROSS-REFERENCE TO RELATED APPLICATION

This non-provisional application claims priority under 35 U.S.C. § 119(a) from Japanese Patent Application No. 2025-067150, filed on Apr. 15, 2025, the entire contents of which are incorporated herein by reference.

### FIELD

The present disclosure relates to a measuring apparatus and program for measuring the dimensions of measuring objects.

### BACKGROUND

An image measuring apparatus is a device that captures an image of a measurement object and measures the dimensions of the measurement point of the measurement object by analyzing the image (see, for example, JP2010-169584A). The image measuring apparatus performs measurements through a series of steps: specifying the elements or dimensions of interest in the captured image of the measurement object, obtaining measurement values, setting display modes and tolerances for those values, and saving the measurement results in which these settings are reflected.

Measurements using an image measuring apparatus can be generalized to the above series of measurement procedures. However, the elements and dimensions focused on during measurement differ for each individual measurement object, and therefore, it is not easy for operators to execute measurements after understanding the correct measurement procedure for each individual measurement object. For this reason, functions have been implemented to record measurement procedures for each individual measurement object and to execute recorded measurement procedures. This makes it easier for the operator to understand the specific measurement procedures for each individual measurement object.

### SUMMARY

### Problem to be Solved

The operator can perform measurements correctly by executing a pre-recorded measurement procedure (also called a measurement program) for the measurement object to be measured. However, when measurement procedures for a wide variety of measurement objects are recorded, finding the procedure for the intended measurement object is not easy. This can lead to delays in executing the procedure or erroneously executing the procedure for the wrong measurement object.

An embodiment of the present invention has been made in view of the above problems, and an object thereof is to provide a measuring apparatus and program that enable an operator to easily understand the recorded measurement procedure for the measurement object to be measured.

### Means for Solving the Problems

The measuring apparatus according to an embodiment of the present invention captures an image of a measurement object, and measures dimensions of measurement points of the measurement object by analyzing the image. The measuring apparatus comprises: a mounting stage on which a measurement object is placed; an imaging device that captures an image of the measurement object placed on the mounting stage; a memory that stores a measurement program recording the measurement procedure for a master workpiece associated with a thumbnail image of the master workpiece; a display that displays the image of the measurement object captured by the imaging device and a user interface of measurement application software used for analyzing the image; and a processor that executes the measurement application software. The processor prompts the operator to select a measurement program by displaying the thumbnail images associated with each measurement program on the display using the measurement application software, and executes the measurement procedure recorded in the selected measurement program.

### BRIEF DESCRIPTION OF THE DRAWINGS

FIG. 1 shows an example of the appearance of an image measuring apparatus 1.

FIG. 2 is a schematic diagram showing the internal structure of the image measuring apparatus 1.

FIG. 3 shows a functional block diagram of the image measuring apparatus 1.

FIG. 4 is a diagram showing an example of a screen displayed on display unit 6 by the measurement application software.

FIG. 5 is a diagram showing an example state where a menu panel is displayed on the screen of the measurement application software.

FIG. 6 shows an example display of a menu related to program measurement.

FIG. 7 shows an example display of the measurement program operation window.

FIG. 8 shows another example display of an example display of the measurement program operation window.

FIG. 9 shows an example display of candidate measurement programs identified by the automatic scanning function.

### EMBODIMENTS

Hereinafter, embodiments of the present invention will be described with reference to the drawings. In the following description and drawings, the same reference numeral is attached to the same functional parts, and the functional parts once explained are either omitted or explained to the extent necessary.

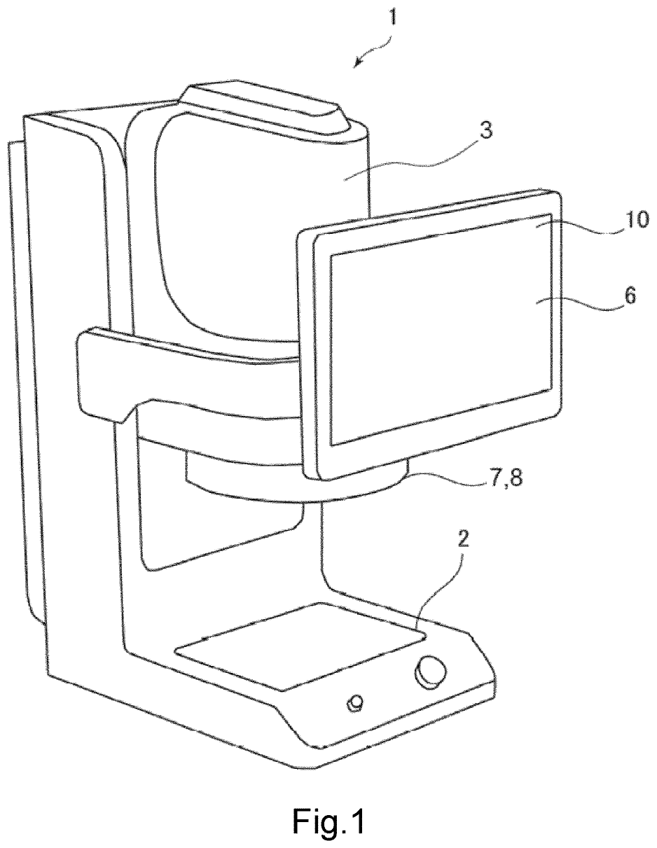

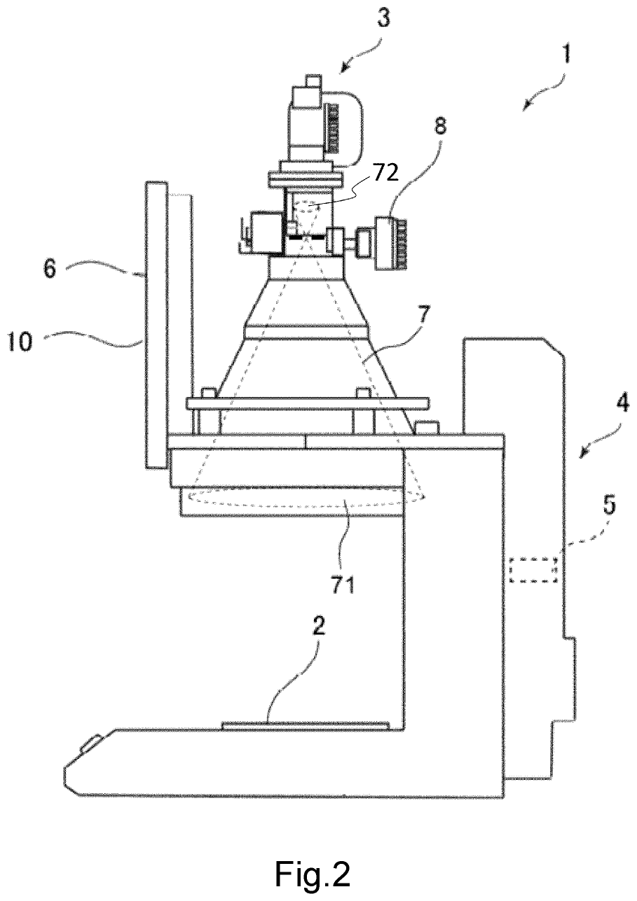

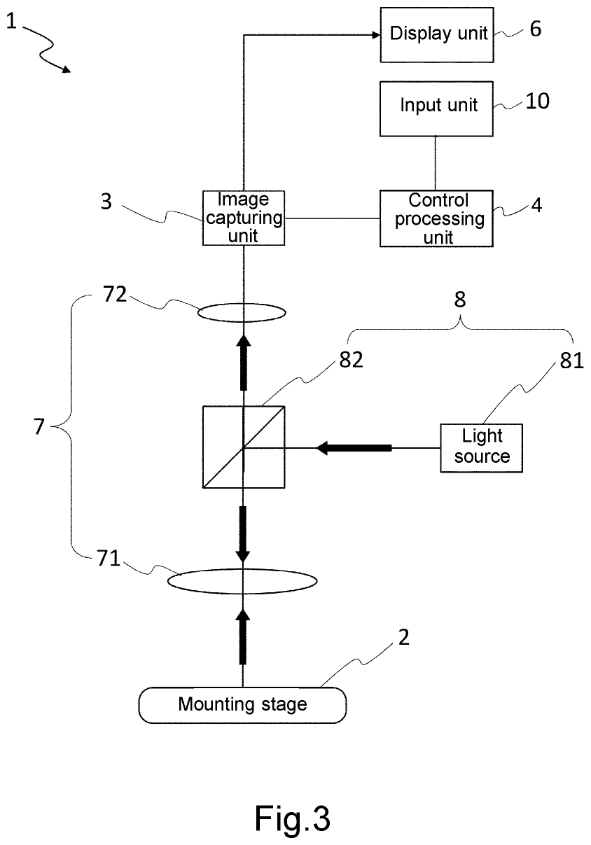

FIG. 1 is a schematic diagram showing an example of the appearance of an image measuring apparatus 1. FIG. 2 is a schematic diagram showing the internal structure of the image measuring apparatus 1. FIG. 3 shows a functional block diagram of the image measuring apparatus 1. In the present embodiment, the case in which the coaxial episcopic illumination is adopted as the illumination method will be explained as an example, but any illumination method is acceptable as long as the image of the measurement object can be captured.

The image measuring apparatus 1 includes a mounting stage 2, an image capturing unit 3, a control processing unit 4, a storage unit 5, a display unit 6, a telecentric optical system 7, an illumination unit 8, and an input unit 10.

The mounting stage 2 is a platform on which a measurement object W is placed. The image capturing unit 3 is disposed opposite the mounting stage 2 and captures images of the measurement object W mounted on the mounting stage 2 by receiving light from the direction of the mounting stage 2. The image capturing unit 3 includes an image sensor, which converts the brightness or darkness of an image formed on its light-receiving surface into an electrical signal, thereby generating image data. For the image sensor, a semiconductor solid-state imaging device such as CCD (Charge-Coupled Device) or CMOS (Complementary Metal Oxide Semiconductor) is used.

The storage unit 5 is an arbitrary storage means (memory) capable of storing digital data. The storage unit 5 stores measurement results obtained by the image measuring apparatus 1, programs executed by the control processing unit 4, and various data used by the programs. Furthermore, the storage unit 5 stores measurement programs in which the operational procedures for measuring individual measurement objects W using the image measuring apparatus 1 are recorded in association with images of the measurement object W (reference images and thumbnail images).

The display unit 6 is an arbitrary display means, and displays the image of the measurement object W captured by the image capturing unit 3, etc.

The telecentric optical system 7 includes an objective lens 71 that collects light from the direction of the mounting stage 2 and an imaging lens 72 that forms an image of the light arriving through the objective lens 71 on the light-receiving surface of the image capturing unit 3. The objective lens 71 and the imaging lens 72 may have a plurality of lens surfaces, respectively.

The illumination unit 8 is a coaxial episcopic illumination means provided with a light source 81 that emits illumination light and a beam splitter 82 that interrupts the illumination light from the light source 81 into the telecentric optical system 7 and directs the light toward the mounting stage 2 as coaxial episcopic illumination light whose optical axis coincides with that of the image capturing unit 3. The illumination unit 8 may be equipped with transillumination or side illumination in addition to the coaxial episcopic illumination for image clarity and other purposes.

The input unit 10 accepts input operations by the operator. The input unit 10 may be configured as a touch panel display integrated with the display unit 6, for example. In addition, the input unit 10 may be provided with a mouse in addition to or in place of the touch panel display.

The control processing unit 4 is composed of a CPU. The control processing unit 4 controls each part in the image measuring apparatus 1 and performs necessary arithmetic processing to realize image capture and image measurement by the image measuring apparatus 1 by executing various programs. The various programs include programs describing functions to control the image capturing unit 3, the illumination unit 8, etc., and programs for the image measurement application that perform measurements such as the dimensions of various parts of the measurement object W using the image of the measurement object W captured by the image capturing unit 3. The program may be read from the storage unit 5 or from another storage medium.

Next, the measurement application software, one of the programs executed by the control processing unit 4, will be described.

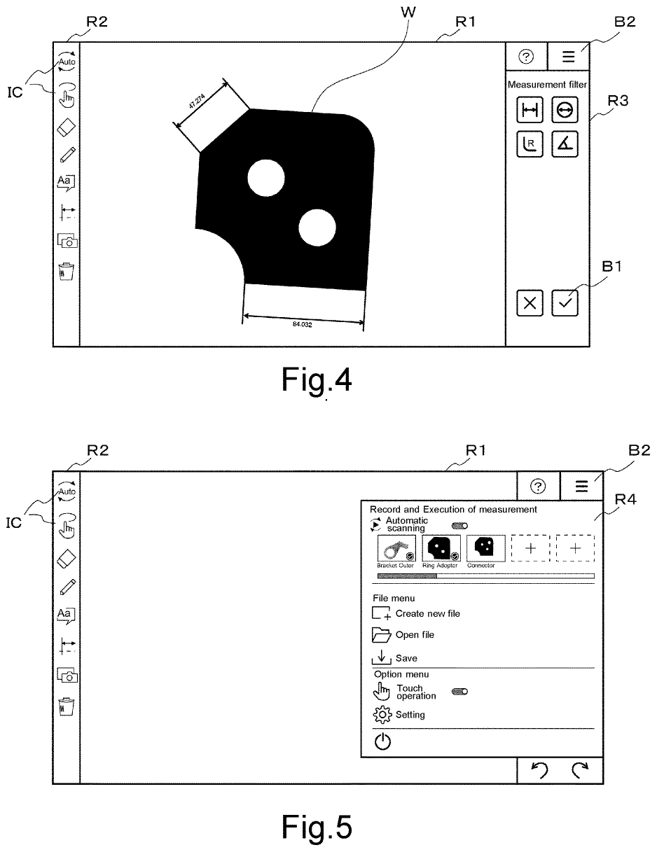

FIG. 4 is a diagram showing an example of a screen displayed on display unit 6 by the measurement application software. Camera view R1 is an area where the image captured by the image capturing unit 3 is displayed. Toolbar R2 is an area where icons IC for calling frequently used functions in the measurement application software are displayed. When the operator taps the icon displayed on this toolbar R2, the function corresponding to the tapped icon is executed. Option panel R3 is an area where various user interfaces necessary for measurement operations are displayed, including buttons such as the confirmation button B1 and menu button B2, icons, slider bars, text boxes, toggle switches, etc.

Measurements using such measurement application software typically follow a series of steps: while an image captured by the image capturing unit 3 is displayed in the camera view R1, the operator specifies the elements or dimensions of interest for measurement, obtains the measured values, sets display mode or tolerances for the measured values, and saves the measurement results in which these settings are reflected.

Measurements using an image measuring apparatus can be generalized to the above series of procedures. However, the elements and dimensions focused on during measurement differ for each individual measurement object, and therefore, it is not easy for operators to execute measurements after understanding the appropriate measurement content and procedures for each individual measurement object. The measurement application software of the present embodiment includes a program measurement function that records a measurement program for each individual measurement object and executes the recorded measurement program. This function facilitates the operator's understanding of the specific measurement procedures for each measurement object. The following describes these functions of the measurement application software.

Pressing the menu button B2 in the upper right corner of the measurement application software screen opens the menu panel R4, as shown in FIG. 5, to display menus related to program measurement along with file menus for opening and saving measurement result files and option menus for various settings of the image measuring apparatus 1.

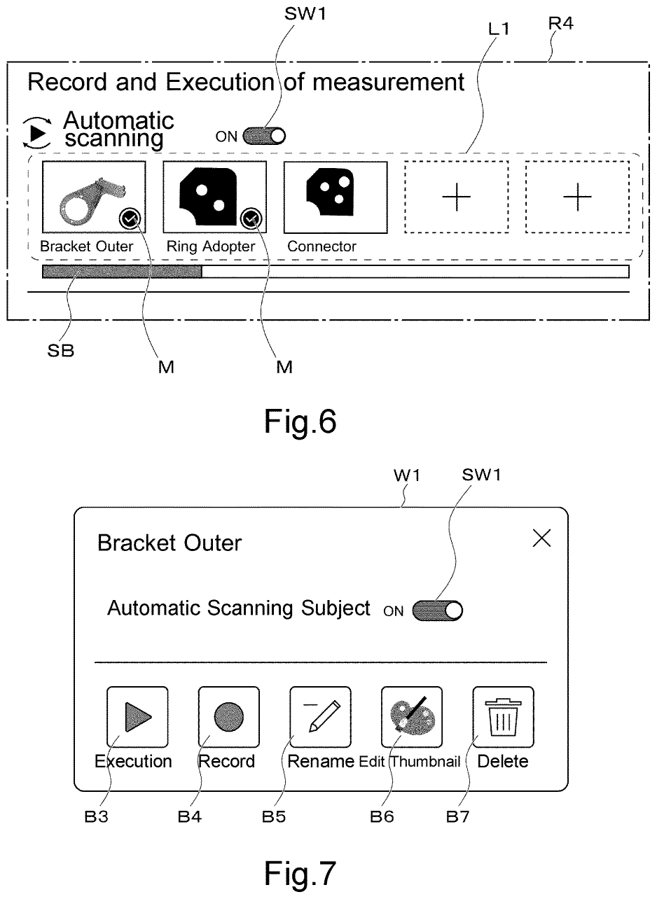

FIG. 6 shows an example display of a menu related to program measurement. The menus related to program measurement are composed of a toggle switch SW1 to enable or disable the automatic scanning described later, a selection list L1 displaying thumbnail images and names of preregistered measurement programs arranged in a predetermined number, and a slide bar SB to scroll the display of selection list L1 left and right The number of measurement programs that can be displayed in the selection list is arbitrary. By displaying thumbnail images, the operators can quickly and accurately identify the desired measurement program for the measurement object W by observing the thumbnail images.

For measurement programs subject to the automatic scanning function described later, a mark M indicating eligibility for the automatic scanning function is displayed in association with the thumbnail image. In the example shown in FIG. 6, the measurement programs named “Bracket Outer” and “Ring Adapter” are subject to automatic scanning. The display position of the mark is arbitrary, but it is recommended to overlay it on the thumbnail image, for example. Note that in a configuration where all measurement programs are subject to the automatic scanning without allowing selection for individual programs, it is not necessary to display the mark M indicating eligibility for the automatic scanning function.

When the operator taps one of the thumbnail images of the measurement programs displayed in the selection list L1, or taps the empty area marked with a “+”, the measurement program operation window W1 shown in FIG. 7 pops up. In the measurement program operation window W1, the name of the selected measurement program is displayed at the top, and an execution button B3, a record button B4, a rename button B5, a thumbnail image edit button B6, a delete button B7, and a toggle switch SW2 are arranged. The toggle switch SW2 is an input interface for switching the selection of whether the selected measurement program is eligible for the auto-scanning function. When the toggle switch SW2 is turned ON, a mark M appears on the thumbnail image corresponding to the selected measurement program in the selection list L1.

The execution button B3 is a command button for executing the selected measurement program. When the measurement program operation window W1 is popped up and an existing measurement program is selected from the selection list L1, the execution button B3 becomes active. By tapping the execution button B3, the measurement procedures recorded in the measurement program are executed. That is, the control unit automatically proceeds with each step of the measurement (such as extracting elements, selecting elements, selecting measurement values, editing, confirming, saving, etc.), following the same procedures as when the measurement program was recorded. Once the execution begins, the execution button B3 changes to a stop button, which is the command button to stop the execution. During the execution of the measurement program, at steps requiring manual operation by the operator, a prompt is displayed to the operator to perform the operation, and the automatic progression is temporarily paused.

The record button B4 is the command button for recording the measurement program. To record the measurement program, the record button B4 is pressed in the state where the master workpiece is placed on the mounting stage 2. Thereby, the subsequent measurement procedures are recorded. Here, if an existing measurement program is selected from the selection list L1 when popping up the measurement program operation window W1, that existing measurement program is overwritten by a new measurement program. Furthermore, if the “+” button is selected from the selection list L1, a new measurement program is recorded. Once recording begins, the record button B4 changes to a stop button, which is the command button to stop the recording.

After the recording starts, the operator performs a series of measurement procedures, including setting imaging conditions such as lighting, capturing images, extracting elements, selecting elements, selecting dimensions, and editing dimensions, using the various functions of the measurement application software on the master workpiece. Meanwhile, the measurement application software records the procedures of the performed operations. Upon completing the measurement procedures and the operator pressing the stop button, the measurement application software stops recording the measurement steps and captures a reference image and a thumbnail image. At this time, the lighting condition for capturing the reference image is set to a predetermined reference image illumination condition. These recorded measurement procedures, the reference image, and the thumbnail image are then saved in association with each other as a measurement program. For the saved measurement program, the thumbnail image and the measurement program name are displayed in the selection list L1.

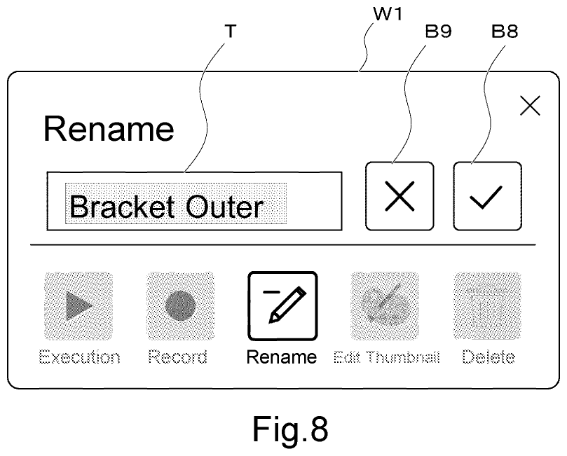

The rename button B5 is a command button for changing the name of the measurement program. By pressing the Rename button B5 in the measurement program operation window W1, a text box T for editing the measurement program name, a Confirm button B8, and a Cancel button B9 are displayed within the measurement program operation window W1, as shown in FIG. 8. By entering the desired name in this text box T and pressing the Confirm button B8, the change to the measurement program name can be confirmed.

Returning to FIG. 7, thumbnail image edit button B6 is a command button for editing the thumbnail images of the measurement program. By pressing the thumbnail image edit button B6 in the measurement program operation window W1, an edit window for editing the thumbnail image is displayed, and the current thumbnail image is shown in this edit window. In this edit window, using a user interface similar to conventional paint software, lines, shapes, text, symbols, etc., can be drawn over the thumbnail image, and the thumbnail image can be overwritten by confirming the edit. When the image measuring apparatus 1 employs a touch panel display, it is advantageous to configure the apparatus to allow freehand writing on the thumbnail image. By drawing characters, shapes, etc., onto the thumbnail image, it becomes easier to distinguish between measurement programs for measurement objects with similar shapes based on the thumbnail image.

The delete button B7 is a command button for deleting the selected measurement program. When the delete button B7 is pressed, the selected measurement program will be deleted. However, before executing the deletion, a confirmation message may be displayed to alert the operator and confirm their intent to delete the measurement program.

To more efficiently identify the measurement program for the measurement object W of interest, the measurement application software includes an automatic scanning function that identifies measurement programs likely to be the measurement program for the measurement object W of interest from among a large number of measurement programs. This automatic scanning function can be enabled by turning toggle switch SW1 ON in the program measurement menu displayed on menu panel R4.

When the automatic scanning function is enabled, the illumination condition is set to a predetermined automatic scanning illumination condition. The automatic scanning illumination condition and the reference image illumination condition may differ, but to enhance comparison accuracy, it is preferable to set the automatic scanning illumination condition and the reference image illumination condition to be the same. Regardless of whether the measurement object W is placed on the mounting stage 2, imaging by the image capturing unit 3 is continuously performed under predetermined illumination conditions. When the measurement object W is placed on the mounting stage 2, the image capturing unit 3 detects that the measurement object W has been placed based on changes in the captured image and initiates the comparison process. The image of the measurement object W obtained through this imaging is then compared with the reference images stored in the storage unit 5 for each measurement program. A matching rate (i.e., a score indicating the similarity between the measurement object W placed on the mounting stage 2 and the measurement object depicted in the reference image) is calculated. By ensuring the illumination condition of the measurement object W matches that of the reference image, the accuracy of the comparison can be enhanced. Based on the calculated matching rate, the measurement application software performs processing to assist in selecting the appropriate measurement program.

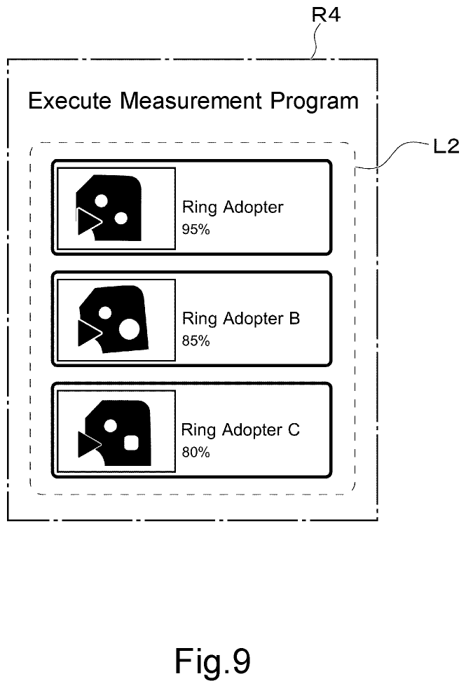

As a process to assist in selecting a measurement program, for example, the measurement application software may identify one or more candidate measurement programs likely to be suitable for the measurement object W placed on the mounting stage 2 based on the matching rate, and display them on the menu panel R4. When displaying multiple candidate measurement programs identified by the automatic scanning function, it is preferable to display them as a list L2 sorted in order of likelihood of suitability for the measurement object W (i.e., in descending order of matching rate), as shown in FIG. 9. At this time, it is desirable to display at least a thumbnail image, name, and matching rate for each measurement program displayed as a candidate. Then, when the operator taps any displayed candidate, the measurement program should be executed.

Alternatively, the measurement program most likely to be suitable for the measurement object W placed on the mounting stage 2 may be automatically executed. To prevent an unsuitable measurement program from being automatically executed, if no measurement program has a matching rate exceeding a predetermined threshold (e.g., 80%), notifications that no suitable measurement program exists may be provided.

According to the image measuring apparatus 1 of the present embodiment described above, by displaying thumbnail images of the measurement object W in the selection list, the operator can immediately identify the measurement program suitable for the intended measurement object W. Even if measurement programs exist for similar measurement objects, by editing the thumbnail images, it becomes easy to recognize which measurement object each individual measurement program corresponds to. Moreover, since the thumbnail images displayed in the selection list occupy a fixed area on the display unit 6, they are suitable for operation on a touch panel display, which is not well-suited for detailed operations.

Furthermore, with the automatic scanning function, it is possible to filter out measurement programs that are likely to be appropriate from a large number of programs, or to automatically execute the measurement programs determined to be appropriate, thereby making measurements more efficient.

In the above embodiment, the measuring apparatus is described as an image measuring apparatus as one example, but the measuring apparatus in the present invention may be a profile projector as well as an image measuring apparatus.

The present invention is not limited to the above embodiments and variations. The above-mentioned embodiments and variations are examples only, and anything having a configuration substantially the same as the technical idea described in the claims of the present invention and producing similar effects is included in the technical scope of the present invention. In other words, changes can be made as appropriate within the scope of the technical ideas expressed in the present invention, and forms with such changes and improvements are also included in the technical scope of the present invention.

For example, in the above embodiment, in the automatic scanning function, the image capturing unit 3 detects that a measurement object W has been placed on the mounting stage 2 based on changes in the images continuously captured. However, it is also possible to detect that a measurement object W has been placed on the mounting stage 2 by other methods. For example, the placement of the measurement object W on the mounting stage 2 may be detected using sensors that detect weight or contact, or sensors that detect distance or position (e.g., LiDAR, ultrasonic sensors, millimeter-wave radar, etc.) without using images captured by the image capturing unit 3.

With respect to the embodiments and modifications thereof, the following appendices are further disclosed.
(Appendix 1)
   A measuring apparatus that captures an image of a measurement object and measures dimensions of the measurement point of the measurement object by analyzing the image, comprising:
   a mounting stage on which the measurement object is placed;
   an imaging device that captures an image of the measurement object placed on the mounting stage;
   a memory that stores a measurement program recording the measurement procedure for a master workpiece associated with a thumbnail image of the master workpiece;
   a display that displays the image of the measurement object captured by the imaging device and a user interface of measurement application software used for analyzing the image; and
   a processor that executes the measurement application software,
   wherein the processor prompts the operator to select the measurement program by displaying the thumbnail images associated with each measurement program on the display by means of the measurement application software, and executes the measurement procedure recorded in the selected measurement program.
(Appendix 2) The measuring apparatus according to Appendix 1, wherein the memory stores the reference images associated with the measurement programs, and
   the processor causes the imaging device to capture the image of the measurement object when the measurement object is placed on the mounting stage, and compares the image of the measurement object captured by the imaging device with the reference images associated with the measurement programs, thereby identifying the measurement program for the master workpiece similar to the measurement object placed on the mounting stage.
(Appendix 3) The measuring apparatus according to appendix 2, wherein the processor identifies one or more measurement programs based on the matching rate between the image of the measurement object captured by the imaging device and the reference image associated with the measurement program, and causes the display to display the thumbnail image associated with the identified measurement program on the display to prompt the operator to make a selection.
(Appendix 4) The measuring apparatus according to Appendix 2, wherein the processor identifies the measurement program for the master workpiece, similar to the measurement object placed on the mounting stage, and executes the identified measurement program.
(Appendix 5) The measuring apparatus according to Appendix 1, wherein the processor records the measurement procedure performed with the master workpiece placed on the mounting stage as the measurement program for the master workpiece, and causes the imaging device to capture an image of the master workpiece placed on the mounting stage, recording the captured image as a reference image associated with the measurement program.
(Appendix 6) The measuring apparatus according to Appendix 5, further comprising an illumination device that irradiates illumination light toward the mounting stage, and
   wherein the processor causes the imaging device to capture the reference image while the illumination device irradiates illumination light under predetermined illumination conditions, and compares the image of the measurement object captured by the imaging device while the illumination device irradiates illumination light under the predetermined illumination conditions with the reference image.
(Appendix 7) The measuring apparatus according to Appendix 1, wherein the processor causes the display to display an edit window for editing the thumbnail image, accepts input to overlay and draw lines, shapes, characters, or symbols onto the thumbnail image within that edit window, and associates the edited thumbnail image with the measurement program in the memory.
(Appendix 8) The measuring apparatus according to Appendix 2, wherein the processor calculates the matching rate between the image of the measurement object captured by the imaging device and the reference image associated with each measurement program, and displays the thumbnail images corresponding to the multiple measurement programs on the display, sorted in descending order of matching rate.
(Appendix 9) The measuring apparatus according to Appendix 2, wherein the processor causes the imaging device to continuously perform image capture, detects that the measurement object has been placed on the mounting stage based on changes in the captured images, and initiates comparison between the image of the measurement object and the reference image in response to the detection.
(Appendix 10) A computer-readable storage medium storing a program for causing a processor to execute a method for controlling the respective parts of the measuring apparatus described in any one of Appendices 1 to 9.

1. A measuring apparatus that captures an image of a measurement object and measures dimensions of the measurement point of the measurement object by analyzing the image, comprising:
a mounting stage on which the measurement object is placed;
an imaging device that captures an image of the measurement object placed on the mounting stage;
a memory that stores a measurement program recording the measurement procedure for a master workpiece associated with a thumbnail image of the master workpiece;
a display that displays the image of the measurement object captured by the imaging device and a user interface of measurement application software used for analyzing the image; and
a processor that executes the measurement application software,
wherein the processor prompts the operator to select the measurement program by displaying the thumbnail images associated with each measurement program on the display by means of the measurement application software, and executes the measurement procedure recorded in the selected measurement program.

2. The measuring apparatus according to claim 1, wherein the memory stores the reference images associated with the measurement programs, and
the processor causes the imaging device to capture the image of the measurement object when the measurement object is placed on the mounting stage, and compares the image of the measurement object captured by the imaging device with the reference images associated with the measurement programs, thereby identifying the measurement program for the master workpiece similar to the measurement object placed on the mounting stage.

3. The measuring apparatus according to claim 1, wherein the processor identifies one or more measurement programs based on the matching rate between the image of the measurement object captured by the imaging device and the reference image associated with the measurement program, and causes the display to display the thumbnail image associated with the identified measurement program on the display to prompt the operator to make a selection.

4. The measuring apparatus according to claim 2, wherein the processor identifies the measurement program for the master workpiece similar to the measurement object placed on the mounting stage and executes the identified measurement program.

5. The measuring apparatus according to claim 2, wherein the processor records the measurement procedure performed with the master workpiece placed on the mounting stage as the measurement program for the master workpiece, and causes the imaging device to capture an image of the master workpiece placed on the mounting stage, recording the captured image as a reference image associated with the measurement program.

6. The measuring apparatus according to claim 5, further comprising an illumination device that irradiates illumination light toward the mounting stage, and
wherein the control unit causes the imaging device to capture the reference image while the illumination device irradiates illumination light under predetermined illumination conditions, and compares the image of the measurement object captured by the imaging device while the illumination device irradiates illumination light under the predetermined illumination conditions with the reference image.

7. The measuring apparatus according to claim 1, wherein the processor causes the display to display an edit window for editing the thumbnail image, accepts input to overlay and draw lines, shapes, characters, or symbols onto the thumbnail image within that edit window, and associates the edited thumbnail image with the measurement program in the memory.

8. The measuring apparatus according to claim 2, wherein the processor calculates the matching rate between the image of the measurement object captured by the imaging device and the reference image associated with each measurement program, and displays the thumbnail images corresponding to the multiple measurement programs on the display, sorted in descending order of matching rate.

9. The measuring apparatus according to claim 2, wherein the processor causes the imaging device to continuously perform image capture, detects that the measurement object has been placed on the mounting stage based on changes in the captured images, and initiates comparison between the image of the measurement object and the reference image in response to the detection.

10. A computer-readable storage medium storing a program for causing a processor to execute a method for controlling the respective parts of the measuring apparatus described in claim 1.
